(19) United States
(12) Patent Application Publication
(10) Pub. No.: US 2025/0026070 A1
(43) Pub. Date: Jan. 23, 2025

(54) LINK MECHANISM, LINK DEVICE, AND STRETCHING MACHINE

(71) Applicant: THE JAPAN STEEL WORKS, LTD., Shinagawa-ku, Tokyo (JP)

(72) Inventors: Masaki KATO, Tokyo (JP); Ichiro NAKAJIMA, Tokyo (JP)

(21) Appl. No.: 18/711,601

(22) PCT Filed: Jul. 14, 2022
(86) PCT No.: PCT/JP2022/027679

§ 371 Date: May 19, 2024

(30) Foreign Application Priority Data
Dec. 7, 2021 (JP) 2021-198461

(51) Int. Cl. B29C 55/16; B29C 55/20

(52) U.S. Cl. CPC B29C 55/165; B29C 55/20

(57) ABSTRACT

A link mechanism 11 constituting a link device used in a stretching machine configured to stretch a film includes a pair of rail holders 24. Each of the rail holders 24 include guide rollers 51a, 51b, 52a, and 52b having openings on both end sides in an axial direction and moving while rotating, hollow shafts 54 and 55 having openings on both end sides in a direction along the axial direction, one sides being fixed to the rail holders 24 and the other sides being inserted into the guide rollers 51a, 51b, 52a, and 52b, bearings 56a, 56b, 57a, and 57b interposed between the guide rollers 51a, 51b, 52a, and 52b and the hollow shafts 54 and 55 and configured to rotatably support the guide rollers 51a, 51b, 52a, and 52b, and flanged shafts 58 and 59 having shaft portions 58a and 59a inserted into the hollow shafts 54 and 55 and flanges 58b and 59b supporting the bearings 56a and 57a.

### TECHNICAL FIELD

The present invention relates to a link mechanism, a link device, and a stretching machine.

### BACKGROUND ART

A stretching machine configured to stretch a sheet, a film, or the like in a longitudinal direction and a transverse direction while conveying it has been known. For example, Patent Document 1 discloses a simultaneous biaxial stretching machine in which longitudinal stretching and transverse stretching of a sheet-like material are performed simultaneously. The simultaneous biaxial stretching machine disclosed in Patent Document 1 includes an endless link device, and the endless link device includes equal-length link units (link mechanisms) formed like a folding scale.

The equal-length link unit disclosed in Patent Document 1 includes a plurality of rollers that are rotatably supported by bearings and move on rails while rotating.

### RELATED ART DOCUMENTS

### Patent Documents

Patent Document 1: Japanese Patent No. 4379306

### SUMMARY OF THE INVENTION

### Problems to be Solved by the Invention

Since a C-shaped retaining ring or the like used for attaching a guide roller may be detached due to vibrations that occur when the link device moves on the rail, the high-speed movement of the link device is obstructed.

Other objects and novel features will be apparent from the description of this specification and the accompanying drawings.

### Means for Solving the Problems

Each of rail holders in a link mechanism according to an embodiment includes a guide roller having openings on both end sides in an axial direction and moving while rotating, a first shaft having openings on both end sides in a direction along the axial direction, one side being press-fitted into the rail holder and the other side being inserted into the guide roller, and a second shaft having a shaft portion inserted into the first shaft and a support portion supporting a bearing.

### Effects of the Invention

According to the embodiment, the high-speed movement of the link mechanism can be achieved.

### BRIEF DESCRIPTIONS OF THE DRAWINGS

FIG. 1 is a schematic view showing a thin-film manufacturing system.

FIG. 2 is a plan view schematically showing a structure of a stretching machine.

FIG. 3 is another plan view schematically showing the structure of the stretching machine.

FIG. 4A is a plan view schematically showing link mechanisms and rails.

FIG. 4B is another plan view schematically showing the link mechanisms and the rails.

FIG. 5 is a plan view showing one of a plurality of link mechanisms in an enlarged manner.

FIG. 6 is a cross-sectional view of the link mechanism.

FIG. 7 is a partially enlarged cross-sectional view showing guide rollers and surrounding structures thereof.

FIG. 8A is a plan view of a part of a rail.

FIG. 8B is a cross-sectional view of the rail.

FIG. 9A is a plan view of one partial rail.

FIG. 9B is a cross-sectional view of the partial rail.

### DETAILED DESCRIPTION OF PREFERRED EMBODIMENTS

Hereinafter, an embodiment will be described in detail with reference to the drawings. Note that the members having the same or substantially same function are denoted by the same reference characters throughout the drawings for describing the embodiment, and the repetitive description thereof will be omitted.

### <Configuration of Manufacturing System>

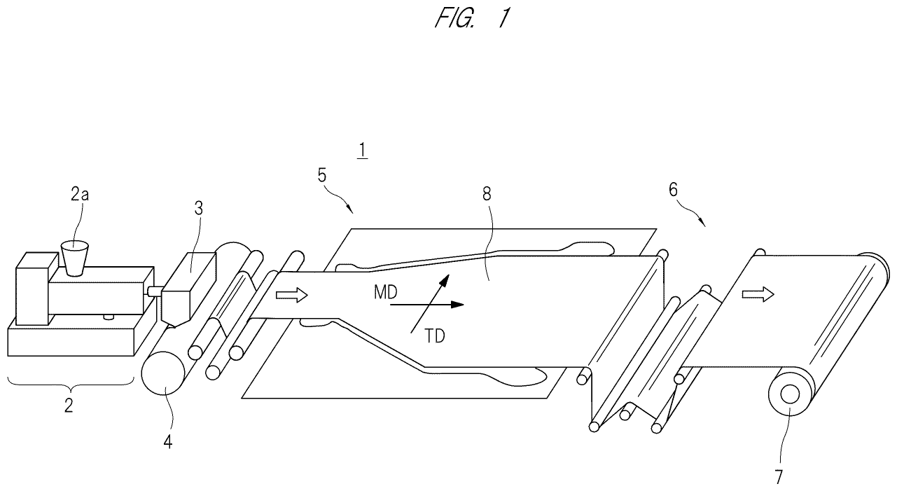

FIG. 1 is a schematic view showing a thin-film manufacturing system including a stretching machine. A thin-film manufacturing system 1 shown in FIG. 1 includes an extrusion apparatus (extruder, kneading extruder) 2, a T-die 3, a raw sheet cooling apparatus 4, a stretching machine 5, a take-off apparatus 6, and a winder apparatus 7.

In the thin-film manufacturing system 1, a thin film is manufactured through the following process. First, a raw material is supplied to a material supply unit (material supply port, hopper) 2a of the extrusion apparatus 2. The raw material to be supplied to the extrusion apparatus 2 contains a resin material (for example, thermoplastic resin material in pellet shape), additives, and the like. The raw material supplied to the extrusion apparatus 2 is conveyed while being kneaded (mixed). Specifically, the raw material supplied to the extrusion apparatus 2 is melted and kneaded while being sent forward by the rotation of a screw in the extrusion apparatus 2. The raw material kneaded by the extrusion apparatus 2 (kneaded material) is supplied to the T-die 3. The kneaded material supplied to the T-die 3 is extruded toward the raw sheet cooling apparatus 4 through a slit of the T-die 3. The kneaded material supplied from the extrusion apparatus 2 to the T-die 3 is formed into a predetermined shape (in this case, film-like shape) by passing through the T-die 3.

The kneaded material extruded from the T-die 3 is cooled to be a film 8 in the raw sheet cooling apparatus 4. The film 8 is a resin film in a solidified state (solid state). More specifically, the film 8 is a thermoplastic resin film. The film 8 is continuously extruded from the T-die 3. As a result, the film 8 is continuously supplied to the stretching machine 5.

The film 8 supplied to the stretching machine 5 is stretched in an MD direction and a TD direction by the stretching machine 5. The film 8 subjected to a stretching process (stretching treatment) by the stretching machine 5 is conveyed to the winder apparatus 7 via the take-off apparatus 6 and is wound by the winder apparatus 7. The film 8 wound by the winder apparatus 7 is cut as needed.

The thin-film manufacturing system 1 shown in FIG. 1 manufactures a thin film through the process described above. Understandably, the thin-film manufacturing system 1 can be modified in various ways in accordance with the properties and the like of the thin film to be manufactured. For example, an extraction tank may be provided near the take-off apparatus 6 shown in FIG. 1, and a plasticizer (for example, paraffin) contained in the film 8 may be removed in some cases.

The stretching machine 5 constituting the thin-film manufacturing system 1 stretches the film 8 in the MD direction and the TD direction while conveying the film 8 in the MD direction. In other words, the MD (Machine Direction) direction is a conveying direction of the film 8. Also, the TD (Transverse Direction) direction is a direction that intersects the conveying direction of the film 8. Thus, in the following description, the MD direction is referred to as a “conveying direction” or a “longitudinal direction”, and the TD direction is referred to as a “transverse direction” in some cases. The MD direction (conveying direction, longitudinal direction) and the TD direction (transverse direction) are the directions intersecting each other, and are more specifically the directions orthogonal to each other. Namely, the stretching machine 5 shown in FIG. 1 is a stretching machine capable of simultaneously stretching the film 8 in two directions intersecting each other while conveying the film 8, and is referred to as a “simultaneous biaxial stretching machine” in general.

### <Stretching Machine>

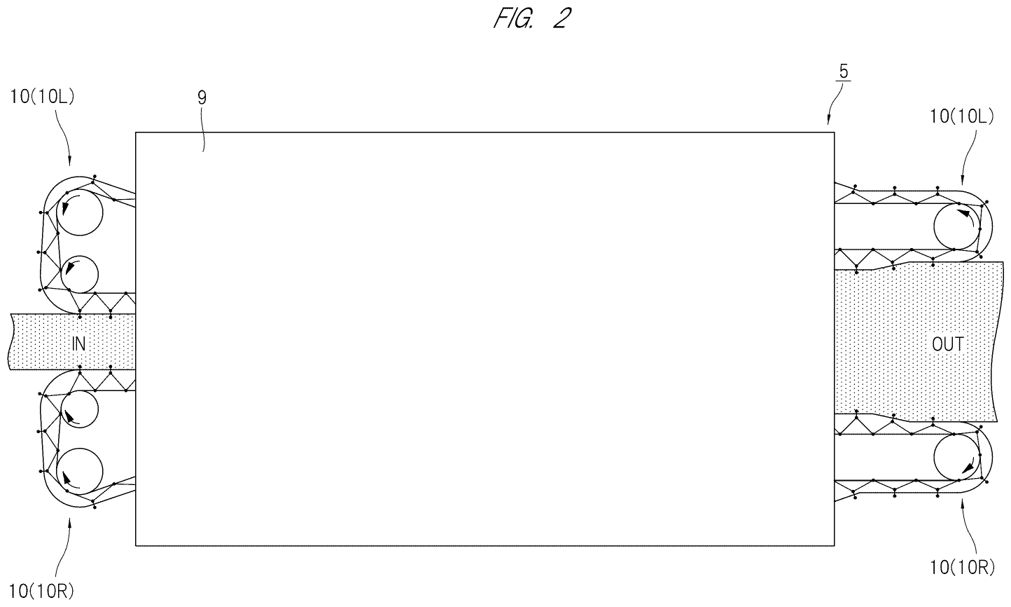

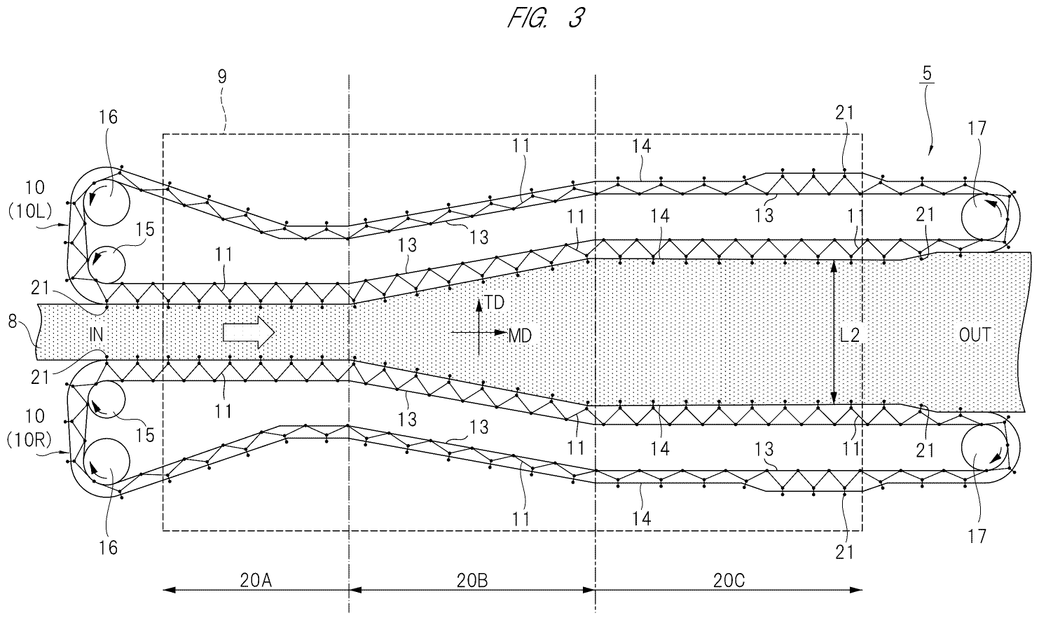

FIG. 2 and FIG. 3 are plan views schematically showing the structure of the stretching machine. The stretching machine 5 has a pair of link devices 10. The pair of link devices 10 are separated from each other in plan view. In the following description, one of the pair of link devices 10 is referred to as a “link device 10R”, and the other of the pair of link devices 10 is referred to as a “link device 10L” in some cases.

In FIG. 2 and FIG. 3, the link device 10R is disposed on a right side (R side) with respect to the conveying direction (MD direction), and the link device 10L is disposed on a left side (L side) with respect to the conveying direction (MD direction). The link device 10R and the link device 10L are separated from each other in the TD direction and face each other in the TD direction with the film 8 interposed therebetween. The film 8 is conveyed through the space between the link device 10R and the link device 10L in the MD direction. In other words, the space between the link device 10R and the link device 10L facing each other functions as a conveyance path for conveying the film 8.

Referring to FIG. 3, the stretching machine 5 is divided into three regions 20A, 20B, and 20C along the conveying direction (MD direction). The region 20A serves as a preheating region, the region 20B serves as a stretching region, and the region 20C serves as a heat setting region. The regions 20A, 20B, and 20C are arranged in this order in the conveying direction (MD direction).

The inlet of the film 8 in the stretching machine 5 (portion indicated by “IN” in FIG. 2 and FIG. 3) is present in the region 20A. Also, the outlet of the film 8 in the stretching machine 5 (portion indicated by “OUT” in FIG. 2 and FIG. 3) is present in the region 20C. Further, the region 20B in which the stretching process is performed is present between the region 20A in which the inlet of the film 8 is present and the region 20C in which the outlet of the film 8 is present.

A heat treatment unit 9 covers a part of the region 20A, all of the region 20B, and a part of the region 20C. Also, the heat treatment unit 9 covers the central parts of the link devices 10R and 10L, and heats the film 8 conveyed by the link devices 10R and 10L. The heat treatment unit 9 in this embodiment is composed of an oven capable of heating the film 8 to a desired temperature. The film 8 passes through the inside of the oven as the heat treatment unit 9 while being gripped by the link devices 10R and 10L.

### <Link Device>

Each of the link devices 10R and 10L includes a plurality of link mechanisms 11 coupled to constitute an endless chain, and each of the link mechanisms 11 has a clip 21 which is a jig for gripping the film 8. The film 8 is held by the clips 21 in the link mechanisms 11 constituting the link device 10R and the clips 21 in the link mechanisms 11 constituting the link device 10L. Namely, one side (R side/right side) of the film 8 is gripped by the plurality of clips 21 in the link device 10R, and the other side (L side/left side) of the film 8 is gripped by the plurality of clips 21 in the link device 10L.

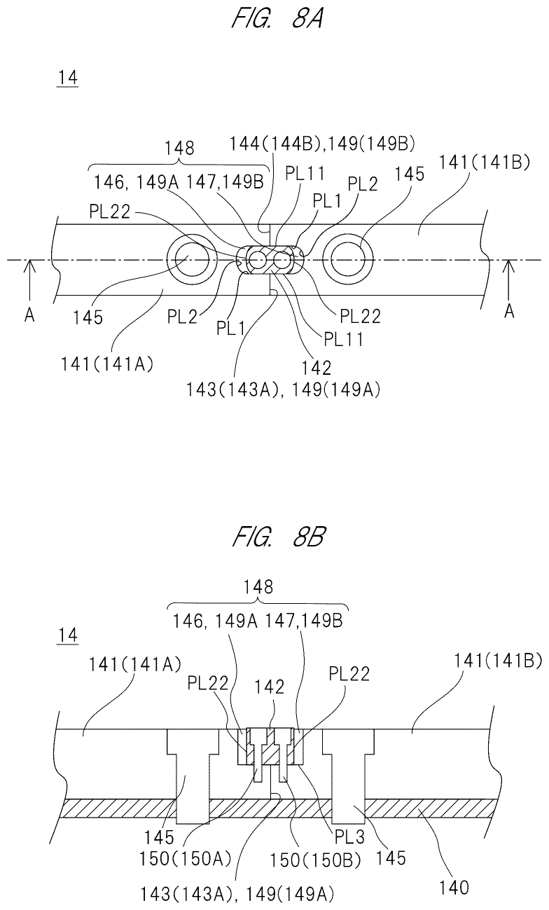

The link mechanisms 11 in the link devices 10R and 10L run on a pair of rails 13 and 14 disposed on a support table (bed) 140 (see FIG. 8B). The rail 14 is disposed outside the rail 13 and surrounds the rail 13. From another viewpoint, the rail 13 is disposed inside the rail 14 and is surrounded by the rail 14.

The rails 13 and 14 are annularly disposed over the regions 20A, 20B, and 20C. More specifically, the rails 13 and 14 are turned back in the region 20A where the inlet of the film 8 is present, are turned back in the region 20C where the outlet of the film 8 is present, and are annularly disposed over the regions 20A, 20B, and 20C.

The link device 10R has three sprockets 15, 16, and 17 disposed inside the rail 13. Similarly, the link device 10L has three sprockets 15, 16, and 17 disposed inside the rail 13. The sprockets 15 and 16 of each of the link devices 10R and 10L are disposed in the region 20A, and the sprocket 17 of each of the link devices 10R and 10L is disposed in the region 20C. Understandably, the sprockets 15 and 16 are disposed outside the heat treatment unit 9 that covers a part of the region 20A. Further, the sprockets 17 are disposed outside the heat treatment unit 9 that covers a part of the region 20C. Namely, the sprockets 15, 16, and 17 of each of the link devices 10R and 10L are disposed outside the oven as the heat treatment unit 9.

The plurality of link mechanisms 11 in the link devices 10R and 10L are disposed on the rails 13 and 14 in a state of being movable along the rails 13 and 14. The sprockets 15, 16, and 17 of the link device 10R engage with the plurality of link mechanisms 11 of the link device 10R. Therefore, when the sprockets 15, 16, and 17 rotate, a driving force acts on the plurality of link mechanisms 11 of the link device 10R, and the link mechanisms 11 move (run) along the rails 13 and 14.

The sprockets 15, 16, and 17 of the link device 10L engage with the plurality of link mechanisms 11 of the link device 10L. Therefore, when the sprockets 15, 16, and 17 rotate, a driving force acts on the plurality of link mechanisms 11 of the link device 10L, and the link mechanisms 11 move (run) along the rails 13 and 14.

Namely, the rails 13 and 14 are guide rails for moving (running) the plurality of link mechanisms 11 in a predetermined direction. Each of the rails 13 and 14 is formed by connecting a plurality of partial rails which will be described later in detail.

In the following description, for each of the link devices 10R and 10L shown in FIG. 3, the side facing the film 8 is referred to as a “film side”, and the side opposite to the film side is referred to as a “return side” in some cases. Namely, the side on which the plurality of link mechanisms 11 move from the inlet (IN) toward the outlet (OUT) while the clips 21 are gripping the film 8 is the film side. Also, the side which is located on the opposite side of the film side and on which the plurality of link mechanisms 11 move from the outlet (OUT) toward the inlet (IN) while the clips 21 do not grip the film 8 is the return side.

An interval between adjacent link mechanisms 11 (referred to also as “link pitch” in some cases) of the plurality of link mechanisms 11 changes in accordance with an interval (separation distance) between the rail 13 and the rail 14. In other words, the interval between the adjacent link mechanisms 11 can be adjusted by adjusting the separation distance between the rail 13 and the rail 14.

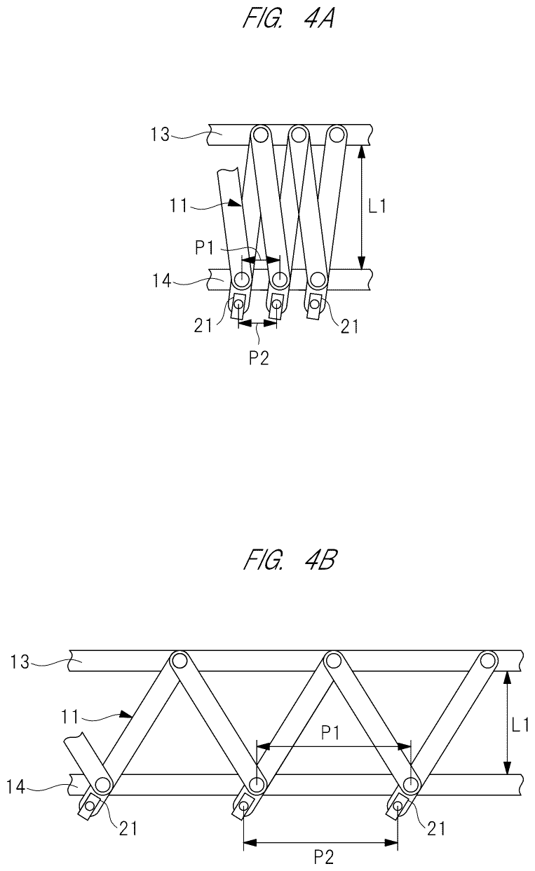

FIG. 4A and FIG. 4B are plan views schematically showing the link mechanisms and the rails shown in FIG. 3. As shown in FIG. 4A and FIG. 4B, the angle formed by the adjacent link mechanisms 11 becomes larger and the pitch P1 between the adjacent link mechanisms 11 becomes larger as the separation distance L1 between the rails 13 and 14 becomes smaller. On the other hand, the angle formed by the adjacent link mechanisms 11 becomes smaller and the pitch P1 between the adjacent link mechanisms 11 becomes smaller as the separation distance L1 between the rails 13 and 14 becomes larger.

As described above, each link mechanism 11 has the clip 21 configured to grip the film 8. Therefore, the pitch P2 between the adjacent clips 21 also increases and decreases in accordance with the increase and decrease of the pitch P1 between the adjacent link mechanisms 11. Specifically, the pitch P1 between the link mechanisms 11 increases when the separation distance L1 between the rails 13 and 14 decreases, and the pitch P2 between the clips 21 also increases when the pitch P1 between the link mechanisms 11 increases (FIG. 4A→FIG. 4B). On the other hand, the pitch P1 between the link mechanisms 11 decreases when the separation distance L1 between the rails 13 and 14 increases, and the pitch P2 between the clips 21 also decreases when the pitch P1 between the link mechanisms 11 decreases (FIG. 4B→FIG. 4A).

Since each of the plurality of link mechanisms 11 includes the clip 21, the pitch P1 between the two adjacent link mechanisms 11 and the pitch P2 between the two clips 21 provided in these link mechanisms 11 are the same. Namely, P1=P2 holds in each of FIG. 4A and FIG. 4B.

### <Operation of Stretching Machine (Simultaneous Biaxial Stretching Machine)>

The film 8 supplied from the raw sheet cooling apparatus 4 to the stretching machine 5 is gripped by the link devices 10R and 10L at the inlet of the stretching machine 5. Specifically, the film 8 is gripped by the clips 21 in the link mechanisms 11 of the link devices 10R and 10L shown in FIG. 2 and FIG. 3. More specifically, one side of the film 8 in the width direction is gripped by the clips 21 in the link mechanisms 11 of the link device 10R, and the other side of the film 8 in the width direction is gripped by the clips 21 in the link mechanisms 11 of the link device 10L.

The film 8 whose both sides in the width direction are gripped by the clips 21 is conveyed from the inlet to the outlet of the stretching machine 5 along with the movement of the link mechanisms 11 including the clips 21, and passes through the region 20A (preheating region), the region 20B (stretching region), and the region 20C (heat setting region) in this order. The film 8 is stretched in the MD direction and the TD direction while passing through the region 20B (stretching region). Thereafter, the film 8 reaches the outlet through the region 20C (heat setting region) and is released from the clips 21. The film 8 released from the clips 21 is conveyed to the take-off apparatus 6 and is further conveyed from the take-off apparatus 6 to the winder apparatus 7.

As shown in FIG. 3, in the region 20A (preheating region), the interval (separation distance in the TD direction) L2 between the rails 13 and 14 of the link device 10R and the rails 13 and 14 of the link device 10L is almost constant. Therefore, the stretching process of the film 8 in the TD direction is not performed in the region 20A. Accordingly, the width (dimension in the TD direction) of the conveyed film 8 does not change and remains constant in the region 20A.

Also, in the region 20A, the interval (separation distance) L1 between the rail 13 and the rail 14 of the link device 10R on the film side is almost constant. Therefore, in the region 20A, the pitch P1 of the link mechanisms 11 of the link device 10R on the film side is almost constant, and thus the pitch P2 of the clips 21 of the link device 10R on the film side is also almost constant. Further, in the region 20A, the interval (separation distance) L1 between the rail 13 and the rail 14 of the link device 10L on the film side is also almost constant. Therefore, in the region 20A, the pitch P1 of the link mechanisms 11 of the link device 10L on the film side is almost constant, and thus the pitch P2 of the clips 21 of the link device 10L on the film side is also almost constant. As a result, the stretching process of the film 8 in the MD direction is not performed in the region 20A. Namely, the stretching process of the film 8 in the TD direction and the MD direction is not performed in the region 20A.

Next, the operation of the stretching machine 5 in the region 20B will be described. In the region 20B, the interval (interval in the TD direction) between the rails 13 and 14 of the link device 10R and the rails 13 and 14 of the link device 10L gradually increases as advancing in the conveying direction (MD direction). Therefore, in the region 20B, the film 8 is pulled and stretched in the TD direction as it advances in the conveying direction (MD direction). In other words, in the region 20B, the width (dimension in the TD direction) of the film 8 gradually increases as it advances in the conveying direction (MD direction).

Also, in the region 20B, the interval (separation distance) L1 between the rail 13 and the rail 14 of the link device 10R on the film side gradually decreases as advancing in the conveying direction (MD direction), and the interval (separation distance) L1 between the rail 13 and the rail 14 of the link device 10L on the film side also gradually decreases. Therefore, in the region 20B, the pitch P1 of the link mechanisms 11 of the link device 10R on the film side gradually increases as advancing in the conveying direction (MD direction), and thus the pitch P2 of the clips 21 of the link device 10R on the film side also gradually increases. Further, in the region 20B, the pitch P1 of the link mechanisms 11 of the link device 10L on the film side gradually increases as advancing in the conveying direction (MD direction), and thus the pitch P2 of the clips 21 of the link device 10L on the film side also gradually increases. As a result, in the region 20B, the film 8 is pulled and stretched in the MD direction as it advances in the conveying direction (MD direction).

Accordingly, in the region 20B, the film 8 is stretched in the TD direction and the MD direction as it advances in the conveying direction (MD direction). Namely, in the region 20B, the stretching process in the TD direction and the MD direction is applied to the film 8.

Next, the operation of the stretching machine 5 in the region 20C will be described. In the region 20C, the interval (interval in the TD direction) between the rails 13 and 14 of the link device 10R and the rails 13 and 14 of the link device 10L is almost constant. Therefore, the stretching process of the film 8 in the TD direction is not performed in the region 20C. Accordingly, the width (dimension in the TD direction) of the conveyed film 8 does not change and remains constant in the region 20C.

Further, in the region 20C, the interval (separation distance) L1 between the rail 13 and the rail 14 of the link device 10R on the film side is almost constant. Therefore, in the region 20C, the pitch P1 of the link mechanisms 11 of the link device 10R on the film side is almost constant, and thus the pitch P2 of the clips 21 of the link device 10R on the film side is also almost constant. Further, in the region 20C, the interval (separation distance) L1 between the rail 13 and the rail 14 of the link device 10L on the film side is almost constant. Therefore, in the region 20C, the pitch P1 of the link mechanisms 11 of the link device 10L on the film side is almost constant, and thus the pitch P2 of the clips 21 of the link device 10L on the film side is also almost constant. As a result, the stretching process of the film 8 in the MD direction is not performed in the region 20C. Namely, the stretching process of the film 8 in the TD direction and the MD direction is not performed in the region 20C. In other words, the region 20C is a region through which the link mechanisms 11 holding the film 8 to which the stretching has been performed pass.

As described above, in the region 20A, the pitch P1 of the link mechanisms 11 of the link device 10R on the film side is kept constant, and the pitch P1 of the link mechanisms 11 of the link device 10L on the film side is also kept constant. Thereafter, in the region 20B, the pitch P1 of the link mechanisms 11 of the link device 10R on the film side and the pitch P1 of the link mechanisms 11 of the link device 10L on the film side are gradually expanded. Then, in the region 20C, the pitch P1 of the link mechanisms 11 of the link device 10R on the film side is kept constant again, and the pitch P1 of the link mechanisms 11 of the link device 10L on the film side is also kept constant again. Therefore, on the film side of each of the link devices 10R and 10L, the pitch P1 of the link mechanisms 11 in the region 20C is larger than the pitch P1 of the link mechanisms 11 in the region 20A. From another viewpoint, on the film side of each of the link devices 10R and 10L, the pitch P2 of the clips 21 in the region 20C is larger than the pitch P2 of the clips 21 in the region 20A. From still another viewpoint, on the film side of each of the link devices 10R and 10L, the separation distance L1 between the rails 13 and 14 in the region 20C is smaller than the separation distance L1 between the rails 13 and 14 in the region 20A.

### <Configuration of Link Mechanism>

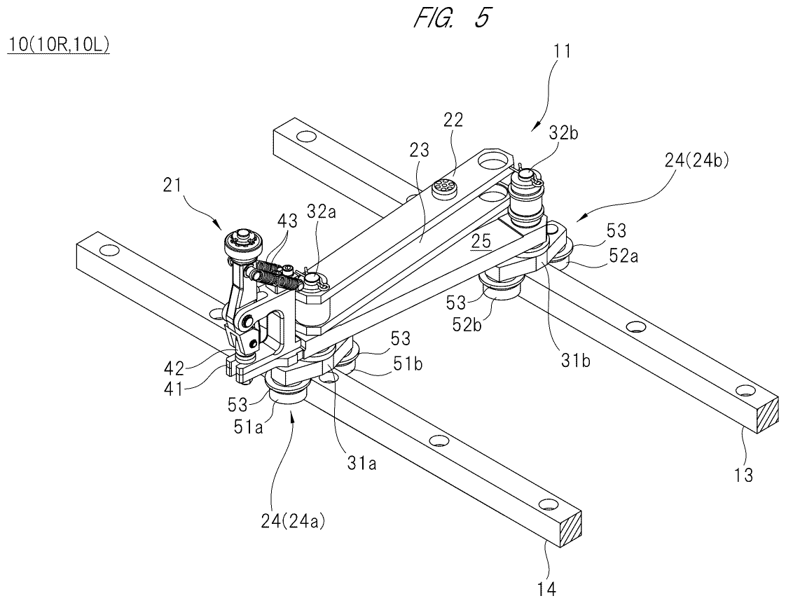

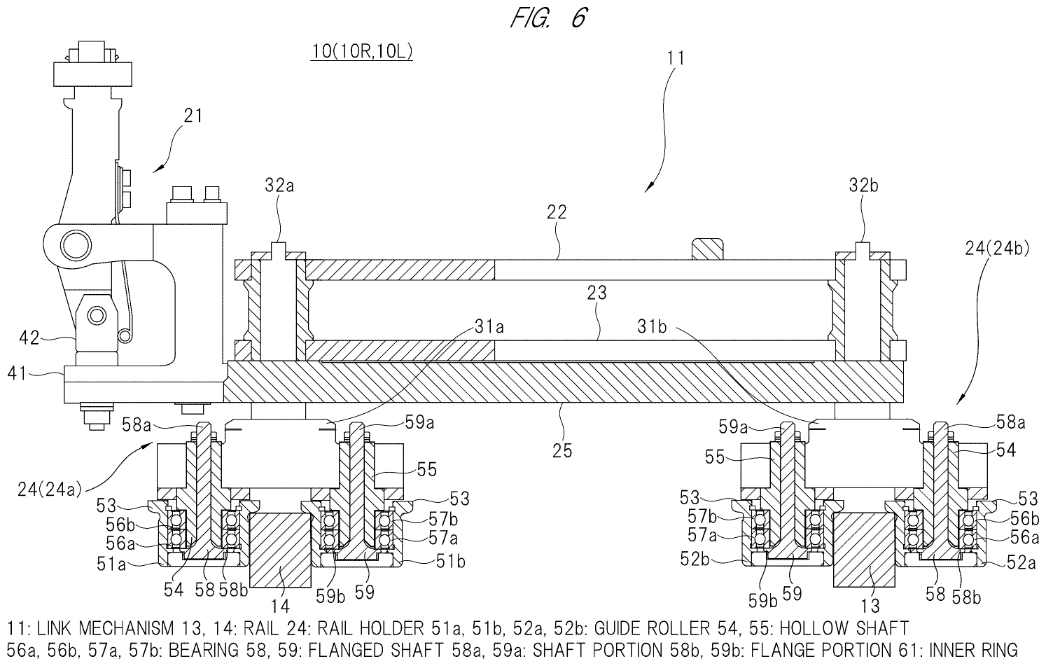

FIG. 5 is a perspective view showing one of the plurality of link mechanisms shown in FIG. 3 in an enlarged manner. FIG. 6 is a cross-sectional view of the link mechanism shown in FIG. 5.

As shown in FIG. 5 and FIG. 6, each of the link mechanisms 11 in the link devices 10R and 10L includes an upper link plate 22, a lower link plate 23, a pair of rail holders 24a and 24b, and a base member 25 bridging the pair of rail holders 24a and 24b in addition to the clip 21. One rail holder 24a is disposed on the rail 14, and the other rail holder 24b is disposed on the rail 13.

The upper link plate 22 and the lower link plate 23 are plate-shaped members that extend linearly in plan view. The base member 25 is common with the upper link plate 22 and the lower link plate 23 in that the base member 25 extends linearly in plan view, but the base member 25 is thicker than the upper link plate 22 and the lower link plate 23. In the following description, the rail holders 24a and 24b are collectively referred to as “rail holders 24” when there is no particular need for distinction therebetween.

### <Rail Holder>

The rail holder 24a includes a roller holding portion 31a and a shaft 32a provided at the center of the roller holding portion 31a in the longitudinal direction. The roller holding portion 31a is disposed on the rail 14 so as to straddle the rail 14. Therefore, one end of the roller holding portion 31a disposed on the rail 14 in the longitudinal direction protrudes toward the inner side of the rail 14 (side facing the rail 13), and the other end of the roller holding portion 31a in the longitudinal direction protrudes toward the outer side of the rail 14 (opposite side of the side facing the rail 13). Also, when the roller holding portion 31a is disposed on the rail 14, the shaft 32a is located just above the rail 14.

As shown in FIG. 6, the shaft 32a of the rail holder 24a penetrates one ends of the upper link plate 22, the lower link plate 23, and the base member 25 in the longitudinal direction. A base end of the base member 25, a base end of the upper link plate 22, and a base end of the lower link plate 23 are skewered with the shaft 32a, and are rotatably coupled with each other via the shaft 32a. In other words, the shaft 32a is a rotating axis on the base end side of the upper link plate 22, the lower link plate 23, and the base member 25.

The rail holder 24b includes a roller holding portion 31b and a shaft 32b provided at the center of the roller holding portion 31b in the longitudinal direction. The roller holding portion 31b is disposed on the rail 13 so as to straddle the rail 13. Therefore, one end of the roller holding portion 31b disposed on the rail 13 in the longitudinal direction protrudes toward the inner side of the rail 13 (side facing the rail 14), and the other end of the roller holding portion 31b in the longitudinal direction protrudes toward the outer side of the rail 13 (opposite side of the side facing the rail 14). Also, when the roller holding portion 31b is disposed on the rail 13, the shaft 32b is located just above the rail 13.

The shaft 32b of the rail holder 24b penetrates one end (tip end) of the base member 25 in the longitudinal direction and protrudes from the base member 25. Namely, the tip end of the base member 25 of the link mechanism 11 and tip ends of the upper link plate 22 and the lower link plate 23 of another adjacent link mechanism 11 are rotatably coupled with each other via the shaft 32b of the link mechanism 11. From another viewpoint, the shaft 32b is a rotating axis on the tip end side of the upper link plate 22, the lower link plate 23, and the base member 25.

### <Clip>

The clip 21 is provided at the base end of the base member 25. The clip 21 includes a main body portion 41, a grip portion 42, a spring portion 43, and others. The main body portion 41 is fixed to the base end of the base member 25. The grip portion 42 is attached to the main body portion 41 so as to be operable in an up-down direction. The spring portion 43 biases the grip portion 42 so as to operate the grip portion 42 downward. By making the grip portion 42 operate downward by the biasing force of the spring portion 43, the film 8 is sandwiched between the main body portion 41 and the grip portion 42. Namely, the film 8 is gripped by the clip 21. On the other hand, by making the grip portion 42 operate upward against the biasing force of the spring portion 43, the film 8 is released from the clip 21.

### <Guide Roller>

A pair of guide rollers 51a and 51b facing each other with the rail 14 interposed therebetween are provided in a lower portion of the rail holder 24a, and a pair of guide rollers 52a and 52b facing each other with the rail 13 interposed therebetween are provided in a lower portion of the rail holder 24b. The guide rollers 51a, 51b, 52a, and 52b are made of metal. Each of the guide rollers 51a, 51b, 52a, and 52b has a cylindrical shape with openings at both ends in the axial direction, and a flange 53 protruding in a radially outward direction is integrally formed on one end side (upper portion) in the axial direction.

The flanges 53 of the guide rollers 51a and 51b provided in a lower portion of the rail holder 24a are disposed on the rail 14, and the flanges 53 of the guide rollers 52a and 52b provided in a lower portion of the rail holder 24b are disposed on the rail 13. More specifically, the flange 53 of the guide roller 51a overlaps the outer edge of the upper surface of the rail 14 (on the opposite side of the side facing the rail 13), and the flange 53 of the guide roller 51b overlaps the inner edge of the upper surface of the rail 14 (on the side facing the rail 13). Also, the flange 53 of the guide roller 52a overlaps the outer edge of the upper surface of the rail 13 (on the opposite side of the side facing the rail 14), and the flange 53 of the guide roller 52b overlaps the inner edge of the upper surface of the rail 13 (on the side facing the rail 14). Thus, the entire link mechanism 11 is supported by the rails 13 and 14 via the guide rollers 51a and 51b of the rail holder 24a and the guide rollers 52a and 52b of the rail holder 24b.

In other words, the guide rollers 51a, 51b, 52a, and 52b are support rollers that support the link mechanism 11. More specifically, the guide rollers 51a, 51b, 52a, and 52b are cantilever support rollers that support the link mechanism 11 by means of the flanges 53 provided on one end side (upper portion) in the axial direction. From another viewpoint, the guide rollers 51a, 51b, 52a, and 52b are flanged rollers having the integrally formed flanges 53.

The four guide rollers 51a, 51b, 52a, and 52b have the same shape, structure, dimension, and the like. Therefore, by describing the shape, structure, and the like of the guide rollers 51a and 51b provided in the rail holder 24a in more detail, the shape, structure, and the like of the guide rollers 52a and 52b provided in the rail holder 24b will also be clarified.

As shown in FIG. 6, the roller holding portion 31a of the rail holder 24a is attached to the lower end of the shaft 32a protruding downward from the base member 25 so as to be rotatable about the shaft 32a as a rotating axis. Specifically, the roller holding portion 31a is attached to the lower end of the shaft 32a via bearings.

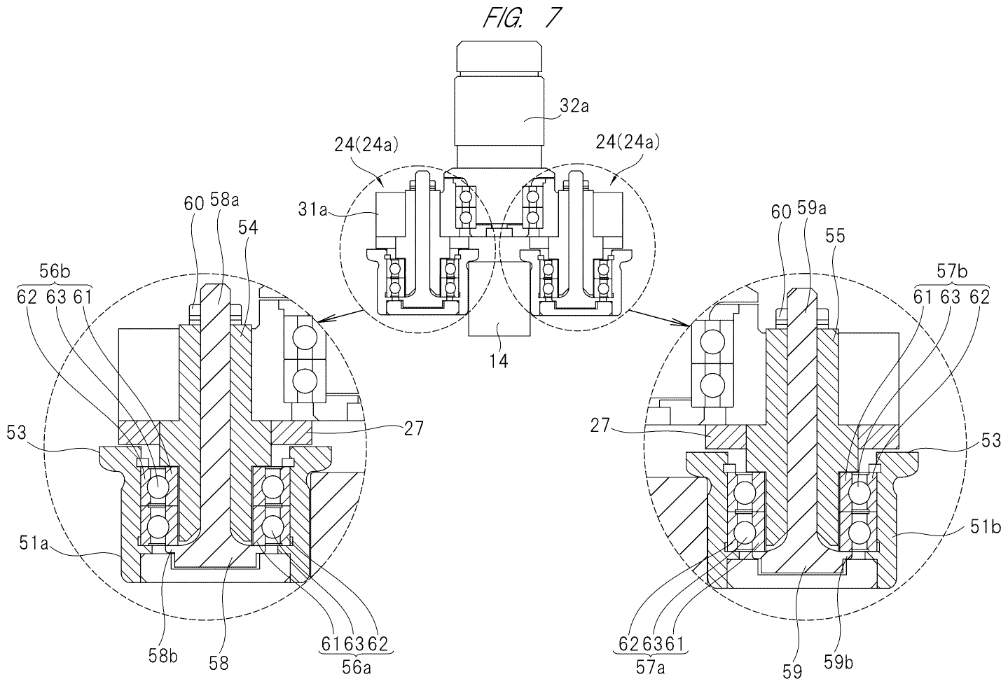

FIG. 7 is a partially enlarged cross-sectional view showing the guide rollers 51a and 51b and surrounding structures thereof shown in FIG. 6. As shown in FIG. 7, shafts (hollow shaft 54 and flanged shaft 58) are provided on one end side of the roller holding portion 31a protruding toward the outer side of the rail 14, and other shafts (hollow shaft 55 and flanged shaft 59) are provided on the other end side of the roller holding portion 31a protruding toward the inner side of the rail 14. In the following description, the side close to the rail 14 with respect to the roller holding portion 31a is referred to as a lower side, and the side opposite to the rail 14 with respect to the roller holding portion 31a is referred to as an upper side in some cases.

### <Hollow Shaft>

The hollow shaft 54 is a hollow cylindrical member that extends in an up-down direction. One side (upper portion) of the hollow shaft 54 is press-fitted into a mounting hole provided on one end side of the roller holding portion 31a, and the other side (lower portion) of the hollow shaft 54 protrudes toward the lower side of the roller holding portion 31a. Similarly, one side (upper portion) of the hollow shaft 55 is press-fitted into a mounting hole provided on the other end side of the roller holding portion 31a, and the other side (lower portion) of the hollow shaft 55 protrudes toward the lower side of the roller holding portion 31a. Accordingly, since the hollow shafts 54 and 55 are attached in a state of being fixed to the roller holding portion 31a, the occurrence of detachment of the hollow shafts 54 and 55 due to vibrations applied to the rail holder 24 is suppressed. Namely, the vibration resistance of the hollow shafts 54 and 55 is improved.

Note that the hollow shaft 55 is not limited to that configured to be press-fitted into the roller holding portion 31a. For the attachment of the hollow shaft 55 to the roller holding portion 31a, any attachment method capable of fixing the hollow shaft 55 with vibration resistance can be applied.

Covers 27 are provided on the lower side of the roller holding portion 31a. Openings are formed in the covers 27, and the covers 27 are mounted by inserting lower portions of the hollow shafts 54 and 55 protruding toward the lower side into the openings. The covers 27 are made of, for example, a material such as metal or resin, and are provided to prevent splashed oil or the like from entering bearings 56a, 56b, 57a, and 57b described below when the link mechanism 11 moves (runs) on the rails 13 and 14.

### <Bearing>

The guide roller 51a is attached to the lower portion of the hollow shaft 54 protruding toward the lower side so as to be rotatable on the lower side of the cover 27. Specifically, the other side (lower portion) of the hollow shaft 54 is inserted into the guide roller 51a, and a bearing 56a and a bearing 56b are interposed between the guide roller 51a and the lower portion of the hollow shaft 54. The bearing 56a and the bearing 56b are provided so as to overlap in the axial direction of the hollow shaft 54. Namely, the guide roller 51a is rotatably supported with respect to the hollow shaft 54 by the two bearings 56a and 56b. Since the bearings 56a and 56b overlap in two upper and lower stages, the bearing 56a is referred to as a “lower bearing 56a”, and the bearing 56b is referred to as an “upper bearing 56b” in some cases in the following description.

Also, the guide roller 51b is attached to a protruding portion of the hollow shaft 55 protruding toward the lower side so as to be rotatable on the lower side of the cover 27. The other side (lower portion) of the hollow shaft 55 is inserted into the guide roller 51b, and a bearing 57a and a bearing 57b are interposed between the guide roller 51b and the lower portion of the hollow shaft 55. The bearing 57a and the bearing 57b are provided so as to overlap in the axial direction of the hollow shaft 55. Namely, the guide roller 51b is rotatably supported with respect to the hollow shaft 55 by the two bearings 57a and 57b. Since the bearings 57a and 57b overlap in two upper and lower stages, the bearing 57a is referred to as a “lower bearing 57a”, and the bearing 57b is referred to as an “upper bearing 57b” in some cases in the following description.

Each of the bearings 56a and 56b is a rolling bearing (ball bearing) including an inner ring 61, an outer ring 62 surrounding the inner ring 61, and a plurality of rolling elements (balls) 63 disposed between the inner ring 61 and the outer ring 62. A lubricant such as grease is filled in the gap between the inner ring 61 and the outer ring 62. Note that the bearing 57a and the bearing 57b supporting the guide roller 51b are non-contact sealed bearings identical to the bearing 56a and the bearing 56b described above. Namely, the bearing 57a and the bearing 57b each include the inner ring 61, the outer ring 62, and the rolling elements (balls) 63, and a lubricant such as grease is filled between the inner ring 61 and the outer ring 62.

### <Flanged Shaft>

The flanged shaft 58 includes a shaft portion 58a and a flange portion 58b. The shaft portion 58a extends along the axial direction (up-down direction) of the hollow shaft 54 and is inserted into the hollow shaft 54 from the lower side. A part (upper portion) of the shaft portion 58a protrudes toward an upper side of the hollow shaft 54. The flanged shaft 58 is fixed to the hollow shaft 54 by a retaining member 60 such as a nut via an anti-loosening member such as a washer at the protruding upper portion of the shaft portion 58a.

The flanged shaft 59 includes a shaft portion 59a and a flange portion 59b. The shaft portion 59a extends along the axial direction (up-down direction) of the hollow shaft 55 and is inserted into the hollow shaft 55 from the lower side. A part (upper portion) of the shaft portion 59a protrudes toward an upper side of the hollow shaft 55. The flanged shaft 59 is fixed to the hollow shaft 55 by a retaining member 60 such as a nut via an anti-loosening member such as a washer at the protruding upper portion of the shaft portion 59a.

As described above, the hollow shafts 54 and 55 are attached to the roller holding portion 31a with improved vibration resistance. Therefore, the vibration resistance of the flanged shafts 58 and 59 fixed to the hollow shafts 54 and 55 is also improved similarly.

The flange portion 58b is formed on a lower side of the shaft portion 58a. The flange portion 58b is a support portion that supports the lower bearing 56a interposed between the hollow shaft 54 and the guide roller 51a from the lower side. Specifically, the flange portion 58b is in contact with a lower side of the inner ring 61 of the lower bearing 56a to support the lower bearing 56a from the lower side. The flange portion 59b of the flanged shaft 59 is formed on the lower side of the shaft portion 59a. Similarly to the flange portion 58b, the flange portion 59b is a support portion that supports the lower bearing 57a interposed between the hollow shaft 55 and the guide roller 51b from the lower side. Specifically, the flange portion 59b is in contact with a lower side of the inner ring 61 of the lower bearing 57a to support the lower bearing 57a from the lower side.

In this way, the flanged shafts 58 and 59 can support the guide rollers 51a and 51b without interfering with the rotation of the guide rollers 51a and 51b.

When the rail holder 24 moves on the rail 14, the guide roller 51a moves along an outer side surface of the rail 14 while rotating. When the rail holder 24 moves on the rail 14, the guide roller 51b moves along an inner side surface of the rail 14 while rotating. Similarly, when the rail holder 24 moves on the rail 13, the guide roller 52a moves along an outer side surface of the rail 13 while rotating. When the rail holder 24 moves on the rail 13, the guide roller 52b moves along an inner side surface of the rail 13 while rotating.

As described above, the guide rollers 51 are attached to the roller holding portion 31a by the hollow shafts 54 and 55 and the flanged shafts 58 and 59. Also, the vibration resistance of attachment of the hollow shafts 54 and 55 and the flanged shafts 58 and 59 is improved. Therefore, detachment of members attaching the guide rollers 51a, 51b, 52a, and 52b to the rail holders 24 due to vibrations that occur when the link mechanism 11 moves on the rails 13 and 14 is suppressed. In this way, since the vibration resistance of attachment of the guide rollers 51a, 51b, 52a, and 52b and the rail holders 24 can be improved, it is possible to move the link mechanism 11 on the rails 13 and 14 at a high speed. As a result, since the time required for forming the film 8 can be reduced, it is possible to contribute to improvement of productivity.

### <Connection of Rail>

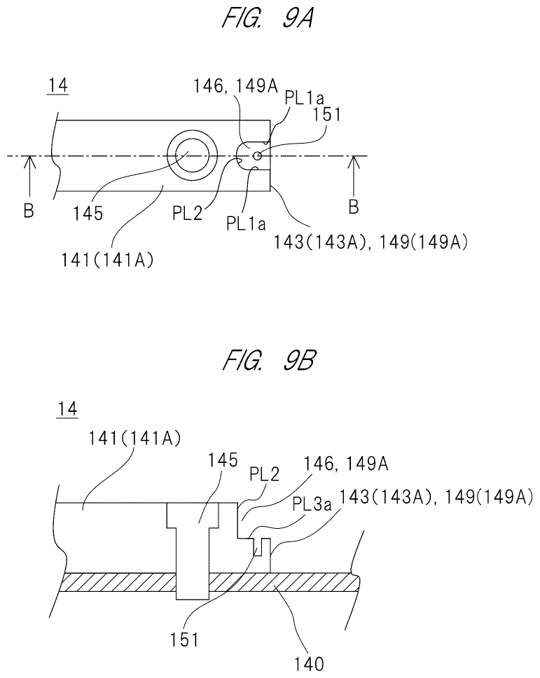

The guide rail on which the link mechanism 11 described above moves (runs) will be described in detail with reference to FIG. 8A, FIG. 8B, FIG. 9A, and FIG. 9B. FIG. 8A is a plan view of a part of the rail 14, and FIG. 8B is a cross-sectional view taken along the line A-A in FIG. 8A. FIG. 9A is a plan view of one partial rail among a plurality of partial rails constituting the rail 14 shown in FIG. 8A, and FIG. 9B is a cross-sectional view of the partial rail taken along the line B-B in FIG. 9A. In the following, the rail 14 will be described as an example of the guide rail, but since the rail 13 also has a structure similar to the rail 14, the description for the rail 14 also applies to the rail 13. Also, in the following description, the surface on which each of the rails 13 and 14 faces the link mechanism 11 is referred to as an upper surface in some cases.

As shown in FIG. 8A and FIG. 8B, the rail 14 has a plurality of partial rails 141 and a coupling member 142 provided in each connection portion 149 in which the respective partial rails 141 are connected. Each partial rail 141 is fixed to the support table (bed) 140 by bolts 145. Each partial rail 141 has connection portions 149 at both ends in an extending direction of the guide rail. A connection portion 149A is an end portion on one side of the partial rail 141. The connection portion 149A has an end surface 143 and a partial groove portion 146. A connection portion 149B is an end portion on the other side of the partial rail 141. The connection portion 149B has an end surface 144 and a partial groove portion 147.

The end surfaces 143 and 144 are surfaces parallel to a plane perpendicular to an extending direction of the partial rail 141. Among the plurality of partial rails 141, an end surface 143A of a partial rail 141A and an end surface 144B of a partial rail 141B shown in FIG. 8A and FIG. 8B face each other. When the partial rails 141 are fixed to the bed 140, the end surface 143A of the partial rail 141A and the end surface 144B of the partial rail 141B become connection surfaces where the partial rails 141 are connected.

### <Partial Groove Portion>

The partial groove portion 146 which is a recess portion is formed in an upper surface of the connection portion 149A of the partial rail 141, and the partial groove portion 147 which is a recess portion is formed in an upper surface of the connection portion 149B. Specifically, as shown in FIG. 9A and FIG. 9B, the partial groove portion 146 is a recess portion that is formed by two side surfaces PL1a, a side surface PL2 connecting one ends of the two side surfaces PL1a on a side opposite to the end surface 143, and a bottom surface PL3a.

The side surfaces PL1a are formed from the end surface 143 along the extending direction of the partial rail 141. The side surface PL2 shown in FIG. 9A is formed in an arc shape protruding toward the side opposite to the end surface 143 on a plane parallel to an upper surface of the partial rail 141. Namely, the side surface PL2 is a curved surface. Note that the side surface PL2 is not limited to the curved surface, and may be, for example, a flat surface along a direction intersecting the extending direction of the partial rail 141. In the bottom surface PL3a, a mounting hole 151 is formed. A bolt 150 attaching the coupling member 142 described below to the partial rail 141 is inserted into the mounting hole 151. Note that the partial groove portion 147 is formed from the end surface 144 along the extending direction of the partial rail 141, and has a shape similar to that of the partial groove portion 146.

When the partial rails 141A and 141B are fixed to the bed 140 and the connection portion 149A and the connection portion 149B face each other, the partial groove portion 146 and the partial groove portion 147 have symmetrical shapes with respect to the end surfaces 143A and 144B of the partial rails 141A and 141B. When the partial rails 141A and 141B are fixed to the bed 140, the partial groove portion 146 and the partial groove portion 147 having the shapes described above and facing each other form a groove portion 148. Namely, it can be said that a part of the groove portion 148 is formed in the partial rail 141A and the remaining part thereof is formed in the partial rail 141B.

The groove portion 148 is a recess portion that is formed by two side surfaces PL1, two side surfaces PL2, and a bottom surface PL3. The side surfaces PL1 are formed by the side surfaces PL1a of the partial groove portion 146 and the side surfaces PL1a of the partial groove portion 147. The side surfaces PL2 are the side surfaces PL2 that form the partial groove portions 146 and 147. The bottom surface PL3 is formed by the bottom surface PL3a of the partial groove portion 146 and the bottom surface PL3a of the partial groove portion 147.

### <Coupling Member>

The coupling member 142 is inserted into the groove portion 148 and is fixed to the partial rails 141 by the bolts 150. As shown in FIG. 8A and FIG. 8B, the coupling member 142 is fixed to the partial rail 141A by a bolt 150A and is fixed to the partial rail 141B by a bolt 150B. As described above, the groove portion 148 is formed by the partial groove portion 146 of the partial rail 141A and the partial groove portion 147 of the partial rail 141B. Accordingly, the coupling member 142 is provided in a part of the partial rail 141A and a part of the partial rail 141B.

Note that the coupling member 142 shown in FIG. 8A and FIG. 8B is fixed to the partial rail 141A by one bolt 150A and is fixed to the partial rail 141B by one bolt 150B, but the present invention is not limited thereto. The coupling member 142 may be fixed to the partial rail 141A by a plurality of bolts 150 and may be fixed to the partial rail 141B by a plurality of bolts 150.

The coupling member 142 is made of a material (for example, metal) having sufficient rigidity with respect to a load acting in a direction intersecting the extending direction of the partial rail 141. The coupling member 142 has two side surfaces PL11 facing the side surfaces PL1 of the groove portion 148 and two side surfaces PL22 facing the side surfaces PL2 of the groove portion 148. A size of the side surface PL11 of the coupling member 142 (that is, a length along the extending direction of the partial rail 141 and a length in a depth direction) and a distance between the two side surfaces PL11 (that is, a length of the coupling member 142 in a direction perpendicular to the extending direction of the partial rail 141) are designed such that the coupling member 142 has sufficient rigidity with respect to the load acting in the direction intersecting the extending direction of the partial rail 141.

The coupling member 142 described above is provided in the partial rails 141 attached to a partial section in the rails 13 and 14. Specifically, the coupling member 142 is inserted and fixed into the groove portion 148 of the partial rails 141 included in the region 20C which is the heat setting region. Note that the present invention is not limited to the case where the coupling member 142 is provided in the partial rails 141 included in the region 20C, and the coupling member 142 may be provided in the partial rails 141 included in the regions 20A and 20B.

In the region 20B which is the stretching region, a neutral point where forces by the sprockets 15, 16, and 17 are balanced is present in the link mechanism 11. In contrast, in the region 20C which is the heat setting region, since the link device 10 is pulled toward the outlet (OUT) side by the sprocket 17, forces are applied from the link mechanisms 11 to the rails 13 and 14. In a section from the neutral point described above to the outlet (OUT), the load acting on the rails 13 and 14 increases in accordance with the number of link mechanisms 11. Therefore, in the region 20C, the load acting from the guide rollers 51a, 51b, 52a, and 52b in the link mechanism 11 to the rails 13 and 14 in the direction intersecting the extending direction of the rails 13 and 14 increases. In particular, when the coupling member 142 described above is not present, the connection portions of adjacent partial rails 141 are deformed in the direction intersecting the extending direction of the rails 13 and 14 due to the load received from the link mechanism 11, and misalignment (step difference) may occur therebetween. Such a step difference causes vibrations when the link mechanism 11 runs, and a problem such as detachment of members attaching the guide rollers 51 to the roller holding portions 31a and 31b may occur. In particular, when the guide rollers 51 are attached by shafts or the like fixed by C-shaped retaining rings or the like without using the hollow shafts 54 and 55 and the flanged shafts 58 and 59 described above, a problem such as detachment of the C-shaped retaining ring may occur.

In contrast, in the present embodiment, the coupling member 142 is provided in the connection portions 149 of the partial rails 141. Therefore, the influence of the load acting in the direction intersecting the extending direction of the rails 13 and 14 is reduced, and the occurrence of the step difference between the connection portions 149 of the adjacent partial rails 141 is suppressed. As a result, the occurrence of vibrations when the link mechanism 11 runs on the connection portions 149 of the partial rails 141 is suppressed, and the occurrence of a problem such as detachment of C-shaped retaining rings, which are members attaching the guide rollers 51 to the roller holding portions 31a and 31b, can be suppressed. In particular, it is possible to suppress the occurrence of a problem such as detachment of the C-shaped retaining ring when the guide rollers 51 are attached by shafts or the like fixed by C-shaped retaining rings or the like without using the hollow shafts 54 and 55 and the flanged shafts 58 and 59 described above. Also, the occurrence of a step difference between the connection portions 149 of the partial rails 141 is suppressed by the coupling member 142, so that the occurrence of vibrations can be suppressed even when the link mechanism 11 is moved at a high speed. Accordingly, since it is possible to achieve the high-speed movement of the link mechanism 11, the time required for forming the film 8 can be reduced, and it is possible to contribute to improvement of productivity.

According to the embodiment described above, the following functional effects are obtained.

(1) The rail holders 24 in the link mechanism 11 include the guide rollers 51a, 51b, 52a, and 52b, the hollow shafts 54 and 55, the bearings 56a, 56b, 57a, and 57b, and the flanged shafts 58 and 59. The guide rollers 51a, 51b, 52a, and 52b have openings on both end sides in the axial direction and move while rotating. The hollow shafts 54 and 55 have openings on both end sides in a direction along the axial direction, and one sides are press-fitted into the rail holders 24 and the other sides are inserted into the guide rollers 51a, 51b, 52a, and 52b. The bearings 56a, 56b, 57a, and 57b are interposed between the guide rollers 51a, 51b, 52a, and 52b and the hollow shafts 54 and 55, and rotatably support the guide rollers 51a, 51b, 52a, and 52b. The flanged shafts 58 and 59 include the shaft portions 58a and 59a inserted into the hollow shafts 54 and 55 and the flange portions 58b and 59b supporting the bearings 56a and 57a.

In this way, detachment of the guide rollers 51a, 51b, 52a, and 52b or the members fixing the guide rollers 51a, 51b, 52a, and 52b to the rail holders 24 due to the vibrations that occur when the link mechanism 11 moves on the rails 13 and 14 is suppressed. Namely, the vibration resistance of fixing of the guide rollers 51a, 51b, 52a, and 52b and the rail holders 24 increases. As a result, it is possible to move the link mechanism 11 on the rails 13 and 14 at a high speed. Accordingly, since it is possible to achieve the high-speed movement of the link mechanism 11, the time required for forming the film 8 can be reduced, and it is possible to contribute to improvement of productivity.

(2) The flange portions 58b and 59b of the flanged shafts 58 and 59 support the inner rings 61 of the lower bearings 56a and 57a on the other side (that is, the lower side) of the hollow shafts 54 and 55. In this way, it is possible to attach the guide rollers 51a, 51b, 52a, and 52b to the roller holding portions 31a and 31b without adversely affecting the rotation of the guide rollers 51a, 51b, 52a, and 52b.

(3) The shaft portions 58a and 59a of the flanged shafts 58 and 59 protrude from the hollow shafts 54 and 55 at the end portions on one side (that is, the upper side) of the hollow shafts 54 and 55, and are fixed to the hollow shafts 54 and 55 with the retaining members 60. In this way, since the flanged shafts 58 and 59 are fixed to the rail holders 24 via the hollow shafts 54 and 55 fixed to the rail holders 24, the vibration resistance of the flanged shafts 58 and 59 is improved.

(4) The rails 13 and 14 on which the link mechanisms 11 run include the plurality of partial rails 141 and the coupling member 142. A part of the coupling member 142 is provided in the partial rail 141A and the remaining part of the coupling member 142 is provided in the partial rail 141B. In this way, it is possible to suppress the occurrence of the step difference between the connection portions 149 of the adjacent partial rails 141 due to the load acting in the direction intersecting the extending direction of the rails 13 and 14. Therefore, since the occurrence of vibrations when the link mechanism 11 passes on the connection portions 149 of the partial rails 141 is suppressed, it is possible to achieve the high-speed movement of the link mechanism 11. As a result, the time required for forming the film 8 can be reduced, and it is possible to contribute to improvement of productivity of the film 8.

(5) The coupling member 142 is attached to the partial groove portion 146 formed in the end surface 143 and the partial groove portion 147 formed in the end surface 144 connected to the end surface 143. In this way, it is possible to suppress the occurrence of the step difference due to the load acting on the rails 13 and 14 with a simple structure.

(6) The coupling member 142 is provided in the partial rail 141A and the partial rail 141B provided in a partial section (that is, the region 20C which is the heat setting region). In the region 20C, the load acting from the link mechanism 11 to the rails 13 and 14 increases in comparison with the other regions 20A and 20B. Thus, by providing the coupling member 142 in the partial rails 141 of the region 20C, it is possible to suppress the occurrence of the step difference between the connection portions of the partial rails 141 due to the load acting on the rails 13 and 14.

In the foregoing, the invention made by the inventors of this application has been specifically described based on the embodiment and example. However, it is needless to say that the present invention is not limited to the embodiment or example described above and various modifications can be made without departing from the gist of the present invention. For example, the guide rollers in each link mechanism 11 are not limited to flanged rollers. Also, the bearings supporting the guide rollers are not limited to the non-contact ball bearings, and may be, for example, contact sealed bearings.

### REFERENCE SIGNS LIST

1 thin-film manufacturing system
2 extrusion apparatus (extruder, kneading extruder)
2a material supply unit (material supply port, hopper)
3 T-die
4 raw sheet cooling apparatus
5 stretching machine
6 take-off apparatus
7 winder apparatus
8 film
9 heat treatment unit
10, 10R, 10L link device
11 link mechanism
13, 14 rail
15, 16, 17 sprocket
20A, 20B, 20C region
21 clip
22 upper link plate
23 lower link plate
24, 24a, 24b rail holder
25 base member
31a, 31b roller holding portion
41 main body portion
42 grip portion
43 spring portion
51a, 51b, 52a, 52b guide roller
53 flange
54, 55 hollow shaft
56a, 57a bearing (lower bearing)
56b, 57b bearing (upper bearing)
58, 59 flanged shaft
58a, 59a shaft portion
58b, 59b flange portion
60 retaining member
61 inner ring
62 outer ring
63 rolling element (ball)
141, 141A, 141B partial rail
142 coupling member
143, 143A, 144, 144B end surface
146, 147 partial groove portion
148 groove portion
149, 149A, 149B connection portion

1. A link mechanism constituting a link device used in a stretching machine configured to stretch a film, the link mechanism comprising:
a pair of rail holders;
a base member bridging the pair of rail holders;
a link plate having one end rotatably coupled to one of the pair of rail holders and the other end rotatably coupled to another link mechanism; and
a clip provided at one end of the base member and configured to grip the film,
wherein each of the rail holders includes:
a guide roller having openings on both end sides in an axial direction and moving while rotating;
a first hollow shaft having openings on both end sides in a direction along the axial direction, one side being fixed to the rail holder and the other side being inserted into the guide roller;
a bearing interposed between the guide roller and the first shaft and configured to rotatably support the guide roller; and
a second shaft having a shaft portion inserted into the first shaft and a support portion supporting the bearing.

2. The link mechanism according to claim 1,
wherein the bearing includes an inner ring, an outer ring, and a rolling element disposed between the inner ring and the outer ring, and
wherein the support portion of the second shaft supports the inner ring.

3. The link mechanism according to claim 1,
wherein an upper portion of the shaft portion of the second shaft protrudes from an upper portion of the first shaft and is fixed to the first shaft by a retaining member.

4. A link device used in a stretching machine configured to stretch a film, the link device comprising:
a plurality of link mechanisms coupled to constitute an endless chain and configured to be movable along two rails,
wherein each of the link mechanisms includes:
a pair of rail holders;
a base member bridging the pair of rail holders;
a link plate having one end rotatably coupled to one of the pair of rail holders and the other end rotatably coupled to another link mechanism; and
a clip provided at one end of the base member and configured to grip the film, and
wherein each of the rail holders includes:
a guide roller having openings on both end sides in an axial direction and moving while rotating;
a first hollow shaft having openings on both end sides in a direction along the axial direction, one side being fixed to the rail holder and the other side being inserted into the guide roller;
a bearing interposed between the guide roller and the first shaft and configured to rotatably support the guide roller; and
a second shaft having a shaft portion inserted into the first shaft and a support portion supporting the bearing.

5. The link device according to claim 4,
wherein the bearing includes an inner ring, an outer ring, and a rolling element disposed between the inner ring and the outer ring, and
wherein the support portion of the second shaft supports the inner ring.

6. The link device according to claim 4,
wherein an upper portion of the shaft portion of the second shaft protrudes from an upper portion of the first shaft and is fixed to the first shaft by a retaining member.

7. A link device used in a stretching machine configured to stretch a film, the link device comprising:
a plurality of link mechanisms coupled to constitute an endless chain; and
a rail on which the link mechanisms run,
wherein the rail includes:
a plurality of partial rails; and
a coupling member provided in connection portions of a first partial rail and a second partial rail among the plurality of partial rails, and
wherein a part of the coupling member is provided in the first partial rail and a remaining part of the coupling member is provided in the second partial rail connected to the first partial rail.

8. The link device according to claim 7,
wherein the coupling member is attached to a first groove portion formed in a first connection portion of the first partial rail and a second groove portion formed in a second connection portion of the second partial rail connected to the first connection portion.

9. The link device according to claim 7,
wherein the coupling member is provided in the first partial rail and the second partial rail of a partial section.

10. The link device according to claim 9,
wherein the partial section is a section where the link mechanisms gripping a stretched film run.

11. A stretching machine comprising:
a pair of link devices configured to convey and stretch a film,
wherein each of the link devices includes a plurality of link mechanisms coupled to constitute an endless chain and configured to be movable along two rails,
wherein each of the link mechanisms includes:
a pair of rail holders;
a base member bridging the pair of rail holders;
a link plate having one end rotatably coupled to one of the pair of rail holders and the other end rotatably coupled to another link mechanism; and
a clip provided at one end of the base member and configured to grip the film, and
wherein each of the rail holders includes:
a guide roller having openings on both end sides in an axial direction and moving while rotating;
a first hollow shaft having openings on both end sides in a direction along the axial direction, one side being fixed to the rail holder and the other side being inserted into the guide roller;
a bearing interposed between the guide roller and the first shaft and configured to rotatably support the guide roller; and
a second shaft having a shaft portion inserted into the first shaft and a support portion supporting the bearing.

12. The stretching machine according to claim 11,
wherein the bearing includes an inner ring, an outer ring, and a rolling element disposed between the inner ring and the outer ring, and
wherein the support portion of the second shaft supports the inner ring.

13. The stretching machine according to claim 11,
wherein an upper portion of the shaft portion of the second shaft protrudes from an upper portion of the first shaft and is fixed to the first shaft by a retaining member.

14. A stretching machine used to stretch a film comprising:
a plurality of link mechanisms coupled to constitute an endless chain; and
a rail on which the link mechanisms run,
wherein the rail includes:
a plurality of partial rails; and
a coupling member provided in connection portions of a first partial rail and a second partial rail among the plurality of partial rails, and
wherein a part of the coupling member is provided in the first partial rail and a remaining part of the coupling member is provided in the second partial rail connected to the first partial rail.

15. The stretching machine according to claim 14,
wherein the coupling member is attached to a first groove portion formed in a first connection portion of the first partial rail and a second groove portion formed in a second connection portion of the second partial rail connected to the first connection portion.

16. The stretching machine according to claim 14,
wherein the coupling member is provided in the first partial rail and the second partial rail of a partial section.

17. The stretching machine according to claim 16,
wherein the partial section is a section where the link mechanisms gripping a stretched film run.
